(19) United States
(12) Patent Application Publication
(10) Pub. No.: US 2007/0253343 A1
(43) Pub. Date: Nov. 1, 2007

(54) Methods and apparatus for managing RF elements over a network

(76) Inventor: Ajay Malik, San Jose, CA (US)

Correspondence Address: INGRASSIA FISHER & LORENZ, P.C., 7150 E. CAMELBACK, STE. 325, SCOTTSDALE, AZ, 85251, US

(21) Appl. No.: 11/413,972

(22) Filed: Apr. 28, 2006

(51) Int. Cl. H04L 12/28; H04Q 7/20; G08B 1/00; G06F 15/173

(52) U.S. Cl. 370/254; 455/422.1; 340/539.2; 709/223

(57) ABSTRACT

A graphical management system includes a web browser application communicatively coupled to a web service and a graphical management module over a network and a plurality of wireless devices (e.g., RFID readers, access ports, etc.) coupled to the network and having one or more associated antennae. The wireless devices are configured to process data received from a plurality of RF elements (mobile units, 802.11 devices, RF tags, etc.) within range of the antennae. An RF switch coupled to the network is configured to receive the data and transmit the data to the graphical management module, which provides to the web service graphical information relating to the state of the RF elements (e.g., location information, heat maps, intrusion detection, self-healing status, etc.)

### TECHNICAL FIELD

The present invention relates generally to radio frequency identification (RFID) systems, wireless local area networks (WLANs), and any other network incorporating RF elements, and, more particularly, to user interfaces and services for real-time management, monitoring and configuration of such systems in an integrated manner.

### BACKGROUND

Due the size of modem wireless networks, it has become difficult to plan, monitor, manage, and troubleshoot the system as a whole as well as the individual radio frequency (RF) elements. For example, radio frequency identification (RFID) systems have achieved wide popularity in a number of applications, as they provide a cost-effective way to track the location of a large number of assets in real time. In large-scale application such as warehouses, retail spaces, and the like, many RFID tags may exist in the environment. Likewise, multiple RFID readers are typically distributed throughout the space in the form of entryway readers, conveyer-belt readers, mobile readers, etc., and may be linked by network controller switches and the like.

Similarly, there has been a dramatic increase in demand for mobile connectivity solutions utilizing various wireless components and wireless local area networks (WLANs). This generally involves the use of wireless access points that communicate with mobile devices using one or more RF channels (e.g., in accordance with one or more of the IEEE 802.11 standards).

The number of mobile units and associated access ports, as well as the number of RFID readers and associated antennae, can be very large in an enterprise. As the number of components increases, the management and configuration of those components becomes complicated and time-consuming. This problem is exacerbated by the presence of handheld, wireless RFID readers and active RFID tags that communicate with access ports rather than standard RFID readers.

Currently, various tools and utilities exist for managing individual types of RF components. However, as these components are often manufactured by different vendors, and incorporate incompatible software interfaces and applications, management of the resulting system is inefficient and time-consuming.

Accordingly, it is desirable to provide an efficient method of managing, con figuring, and troubleshooting diverse types of RF elements in an RF network incorporating, for example, RFID and WLAN systems. Furthermore, other desirable features and characteristics of the present invention will become apparent from the subsequent detailed description and the appended claims, taken in conjunction with the accompanying drawings and the foregoing technical field and background.

### BRIEF SUMMARY

A graphical management system comprises a web browser application communicatively coupled to a web service and a graphical management module over a network and a plurality of wireless devices (e.g., RFID readers, access ports, etc.) coupled to the network and having one or more associated antennae. The wireless devices are configured to process data received from a plurality of RF elements (mobile units, 802.11 devices, RF tags, etc.) within range of the antennae. An RF switch coupled to the network is configured to receive the data and transmit the data to the graphical management module, which provides to the web service graphical information relating to the state of the RF elements (e.g., location information, heat maps, intrusion detection, self-healing status, etc.)

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a system in accordance with an exemplary embodiment of the present invention;

FIG. 2 is a conceptual overview of an exemplary RF switch in accordance with one embodiment;

FIG. 3 depicts various functional domains of the present invention; and

FIG. 4 depicts various components of an exemplary system in accordance with the present invention;

FIG. 5 depicts an exemplary display in the context of a web browser showing the position of networked sites;

FIG. 6 depicts an exemplary display in the context of a web browser showing live mapping of network objects at a site;

FIG. 7 depicts an exemplary display in the context of a web browser showing information for a particular object at a site;

FIG. 8 depicts an exemplary display in the context of a web browser showing the location of particular mobile units or RFID tags at a site;

FIG. 9 depicts an exemplary display in the context of a web browser showing a camera image at a particular location within a site;

FIG. 10 depicts an exemplary display in the context of a web browser showing the relationship between various access ports within a self-healing group;

FIG. 11 depicts an exemplary display in the context of a web browser showing device information;

FIG. 12 depicts an exemplary display in the context of a web browser showing wireless statistics;

FIG. 13 depicts an exemplary display in the context of a web browser showing “heat maps” for access ports at a site; and

FIG. 14 depicts an exemplary display in the context of a web browser showing intrusion detection at a site.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, wireless networks, RFID systems and specifications, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

Without loss of generality, in the illustrated embodiment, many of the functions usually provided by a traditional access point (e.g., network management, wireless configuration, etc.) and/or traditional RFID readers (e.g., data collection, RFID processing, etc.) are concentrated in a corresponding RF switch. It will be appreciated that the present invention is not so limited, and that the methods and systems described herein may be used in conjunction with traditional access points and RFID readers or any other device that communicates via RF channels.

The present invention relates to an improved user interface for real-time location determination, configuration, and coordination of RFID as well as WLAN components. The system provides user-friendly methods of determining the location of objects, such as RFID tags and mobile units, and provides various health monitoring information (self-healing status, “heat maps” for associated antennae, redundancy group status, intrusion detection, and health statistics).

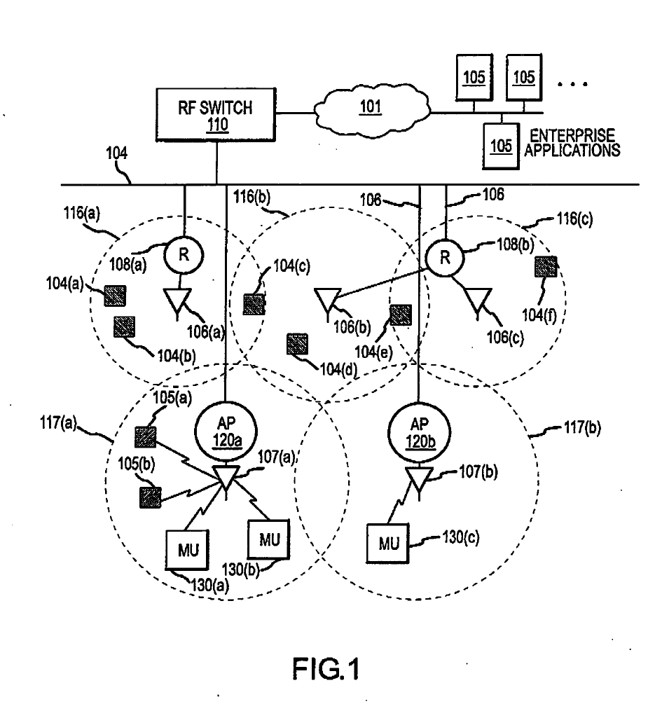

Referring to FIG. 1, in an example system useful in describing the present invention, a switching device 110 (alternatively referred to as an “RF switch” or simply “switch”) is coupled to a networks 101 and 104 (e.g., an Ethernet network coupled to one or more other networks or devices) which communicates with one or more enterprise applications 105. One or more wireless access ports 120 (alternatively referred to as “access ports” or “APs”) are configured to wirelessly connect to one or more mobile units 130 (or “MUs”). APs 120 suitably communicate with switch 110 via appropriate communication lines 106 (e.g., conventional Ethernet lines, or the like). Any number of additional and/or intervening switches, routers, servers and other network components may also be present in the system.

A number of RFID tags (or simply “tags”) 104 are distributed throughout the environment. These tags are read by a number of RFID readers (or simply “readers”) 108 having one or more associated antennas 106 provided within the environment. The term “tag” refers, in general, to any RF element that can be communicated with and has a ID that can be read by another component. Readers 108, each of which may be stationary or mobile, are suitably connective via wired or wireless data links to a RF switch 110.

A particular AP 120 may have a number of associated MUs 130. For example, in the illustrated topology, MUs 130(a) and 130(b) are associated with AP 120(a), while MU 130(c) is associated with AP 120(b). One or more APs 120 may be coupled to a single switch 110, as illustrated.

RF Switch 110 determines the destination of packets it receives over network 104 and 101 and routes those packets to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110. AP 120 is typically capable of communicating with one or more MUs 130 through multiple RF channels. This distribution of channels varies greatly by device, as well as country of operation. For example, in one U.S. embodiment (in accordance with 802.11(b)) there are fourteen overlapping, staggered channels, each centered 5 MHz apart in the RF band.

A particular RFID reader 108 may have multiple associated antennas 106. For example, as shown in FIG. 1, reader 108(a) is coupled to one antenna 106(a), and reader 108(b) is coupled to two antennas 106(b) and 106(c). Reader 108 may incorporate additional functionality, such as filtering, cyclic-redundancy checks (CRC), and tag writing, as is known in the art.

In general, RFID tags (sometimes referred to as “transponders”) may be classified as either active or passive. Active tags are devices that incorporate some form of power source (e.g., batteries, capacitors, or the like), while passive tags are tags that are energized via an RF energy source received from a nearby antenna. While active tags are more powerful, and exhibit a greater range than passive tags, they also have a shorter lifetime and are significantly more expensive. Such tags are well known in the art, and need not be described in detail herein.

Each antenna 106 has an associated RF range (or “read point”) 116, which depends upon, among other things, the strength of the respective antenna 106. The read point 116 corresponds to the area around the antenna in which a tag 104 may be read by that antenna, and may be defined by a variety of shapes, depending upon the nature of the antenna (i.e., the RF range need not be circular or spherical as illustrated in FIG. 1).

It is not uncommon for the RF ranges or read points to overlap in real-world applications (e.g., doorways, small rooms, etc.). Thus, as shown in FIG. 1, read point 116(a) overlaps with read point 116(b), which itself overlaps with read point 116(c). Accordingly, it is possible for a tag to exist within the range of two or more readers simultaneously. For example, tag 104(c) falls within read points 116(a) and 116(b), and tag 104(f) falls within read points 116(b) and 116(c). Because of this, two readers (108(a) and 108(b)) may sense the presence of (or other event associated with) tag 104(c).

As described in further detail below, switch 102 includes hardware, software, and/or firmware capable of carrying out the functions described herein. Thus, switch 102 may comprise one or more processors accompanied by storage units, displays, input/output devices, an operating system, database management software, networking software, and the like. Such systems are well known in the art, and need not be described in detail. Switch 102 may be configured as a general purpose computer, a network switch, or any other such network host. In a preferred embodiment, controller 102 is modeled on a network switch architecture but includes RF network controller software (or “module”) whose capabilities include, among other things, the ability to allow configure and monitor readers 108 and antennas 106.

RF switch 110 allows multiple read points 116 to be logically combined, via controller 102, within a single read point zone (or simply “zone”). For example, referring to FIG. 1, a read point zone 120 may be defined by the logical union of read points 116(a), 116(b), and 116(c). Note that the read points need not overlap in physical space, and that disjoint read points (e.g., read point 116(d)) may also be included in the read point zone if desired. In a preferred embodiment, antennas (i.e., read points defined by the antennas) can be arbitrarily assigned to zones, regardless of whether they are associated with the same reader. That is, referring to FIG. 1, antennas 106(b) and 106(c), while both associated with reader 108(b), may be part of different zones. Controller 102 then receives all tag data from readers 108 via respective data links 103 (e.g., wired communication links, 802.11 connections, or the like), then aggregates and filters this data based on zone information. The read point zones are suitably preconfigured by a user or administrator. That is, the user is allowed to access controller 110 and, through a configuration mode, specify a set of read points that are to be included in a particular zone.

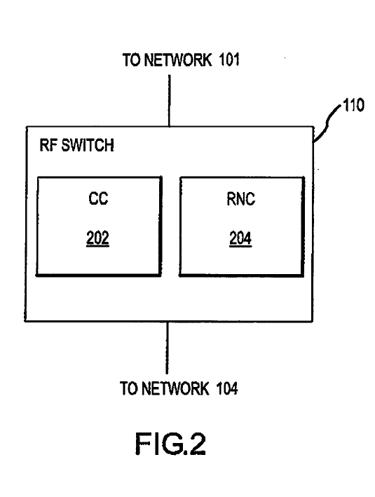

FIG. 2 depicts a conceptual block diagram of an RF switch 110. A shown, switch 110 includes a cell controller (CC) 202, and a RFID network controller (RNC) 204. In general, RNC 204 includes hardware and software configured to handle RFID data communication and administration of the RFID network components, while CC 202 includes hardware and software configured to handle wireless data (e.g., in accordance with IEEE 802.11) from the mobile units and access ports within wireless cells. In one embodiment, RF switch 110 includes a single unit with an enclosure containing the various hardware and software components necessary to perform the various functions of CC 202 and RNC 204. Switch 110 also includes suitable input/output hardware interfaces to networks 101 and 104.

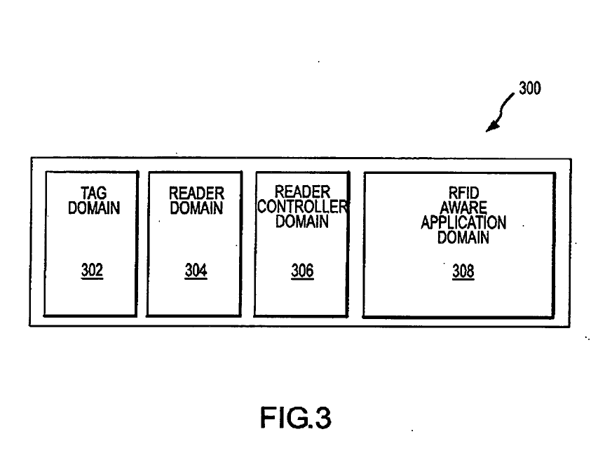

FIG. 3 illustrates, conceptually, the four major domains of an exemplary RF switch network—i.e., tag domain 302, reader domain 304, reader controller domain 306, and RFID-aware application domain 308.

Tag domain 302 comprises tags, tagged assets, and objects that require tracking and/or monitoring (e.g., tags 104 in FIG. 1). As mentioned previously, these tags may be active, passive, or a combination thereof.

Reader domain 304 includes, inter alia, physical antennas 106, readers 108, and APs 120. Objects in reader domain 304 acquire information from objects in tag domain 302 and pass associated data to reader controller domain 306.

Reader controller domain 306 comprises RNC objects. RNC objects (e.g., RNC 204 in FIG. 2) act as an integration point for RFID readers/antennae and include the functionality of filtering and aggregating volumes of data provided by readers 108, supporting the analysis of data and applying local decision making and intelligence. The RNC is preferably compatible with readers from multiple vendors and effectively hide individual reader and tag interface idiosyncrasies from RFID aware application domain 308.

RFID-aware application domain 308 includes one or more standalone applications and/or middleware applications that function as intermediaries between enterprise applications 105 and the RNC. In this regard, the applications within this domain rely on events on a higher level—i.e., events that are important in the context of a business operation or process.

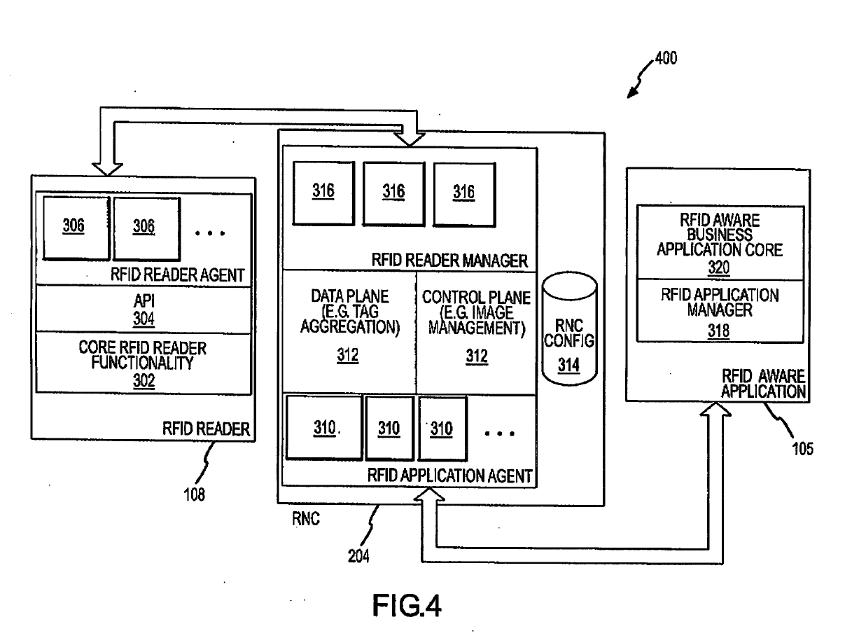

FIG. 4 is a block diagram showing the components of an exemplary system corresponding to the various domains illustrated in FIG. 3. As shown, system 400 generally includes an RFID reader 108, an RNC 204, and an application 105 communicating as shown.

Reader 108 includes one or more reader agents 306, an application programming interface (API) 304, and some core functionality 302. Reader 108, as mentioned above, is responsible for reading RFID tags (embodied within core functionality 302). For active tags read by an AP, switch 110 acts as an RFID reader and communicates the tag info to RNC 204. Reader agents 306 includes the interfaces through which RNC 204 communicates. This may include, for example, a proprietary interface, an SLRRP interface, other any other interface, such as dynamically-loadable modules for other protocols. In one embodiment, RFID reader 108 provides a C# API 304 for core RFID reader functionality 302, and reader agents 306 make use of this API.

Reader 108 implements a suitable RNC discovery procedure. In one embodiment, the reader first makes use of IP subnet broadcast. If no response is received, reader 108 refers to a list of statically configured RNCs 204 (which is preferably stored across reboots in the reader). If no response is received using this method, then reader 108 consults a discovered list of RNCE controllers (also stored across reboots in the reader). This list includes a list of RNCs 204 to which the reader had prior success in joining. If no response is received, Reader 108 uses a list of RNCs received in a DHCP offer (using option 43, known in the art).

RNC 204 includes one or more RFID reader managers 316, a data plane 312, a control plane 312, one or more RFID application agents 310, and a RNC configuration database 314. In one embodiment, RNC includes a set of processes, shared libraries, and the like running under Linux and a local operating system. RFID reader managers 316 communicates with RFID reader 108 using any suitable interface, such as a proprietary interface, SLRRP, or the like. RFID application agents 310 provide suitable interfaces, such as ALE, MQTT, JMS, SQL, IBM Premises Server Interface, or any other suitable interface. Applications 105 includes an RFID-aware business application core 320 and an RFID application manager 318.

Having thus given an overview of an RF network in which the present invention may be deployed, a description of an exemplary RF graphical management system will now be described.

In general, a user is provided a display and user interface (e.g., through a conventional web browser) that allows multiple sites and multiple RF elements to be monitored and managed remotely over a network. Suitable software, hardware, and network services are provided in any appropriate host within the network (e.g., at RF switch 110) such that a user and/or administrator may establish a connection with that host via a client program (e.g., web browser) located on a computer system located elsewhere in the network. That is, a web browser application is communicatively coupled to a web service and a graphical management module over a network The location of the graphical management module software may be within a networked component (e.g., the RF switch) or may be on a stand-alone computer provided somewhere within the network. The nature of web services, browsers, and the like are well known in the art, and thus need not be described herein. Furthermore, it will be appreciated that the various graphical elements and user interface details may be implemented using a variety of methods, protocols, and software tools (e.g., AJAX, CSS, etc.) but that the present invention is not so limited.

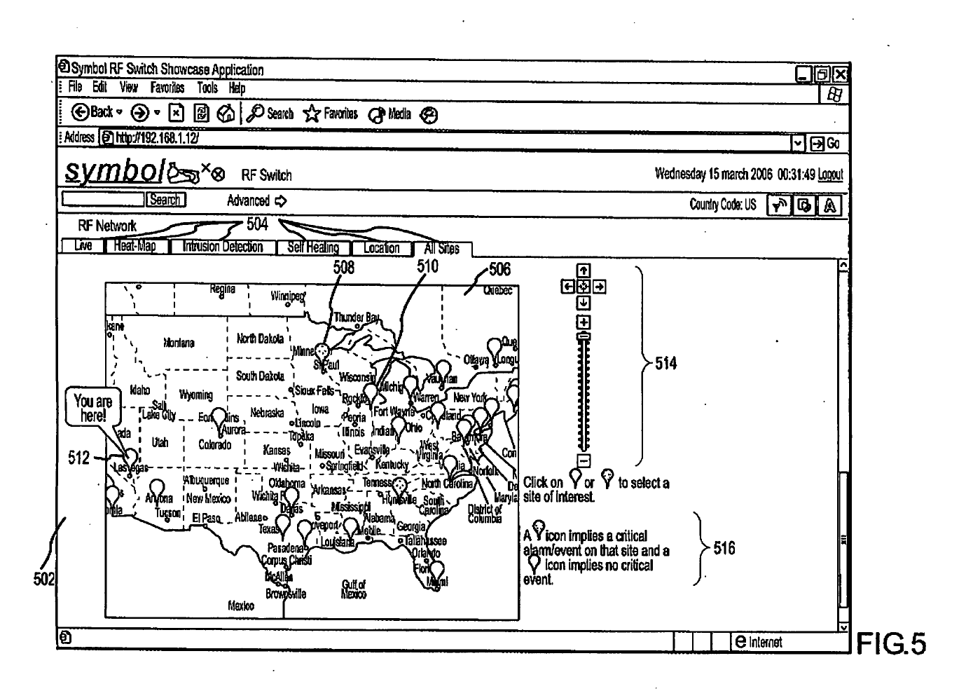

In this regard, FIG. 5 depicts an exemplary display in the context of a web browser showing the position of networked sites within a geographical region. In this display, which is not intended to be limiting with respect to content or layout, a browser region 502 includes a map 506 of a geographical region (in this case, a map of a portion of North America) with sites indicated by site indicators (518, 510, 512, etc.) using any convenient graphical element.

A series of tabs 504 may be employed to allow navigation through the various images. In the illustrated embodiment (and as described further below), the tabs 504 are labeled “Live”, “Heat Map”, “Intrusion Detection”, “Self Healing”, “Location”, and “All Sites.” The illustrated image corresponds to the “All Sites” tab, wherein a plurality of network sites (each having one or more RF elements, switches, etc.) are superimposed over a two-dimensional map.

A standard zooming tool 514 and key 516 may also be provided. In this embodiment, the site indicators include visual cues that relate to the status of that site. For example, in the illustrated embodiment, one color or level of shading is used for sites at which a critical alarm/event has occurred (which may defined in any convenient fashion), while another color is used for sites at which no critical event has occurred. Additional information bubbles, mouse-over events, or other such visual indicators may be used to designate the location of the user (as with a “You are Here” bubble), or any other spatial feature of the network or user. In this way, the administrator may manage multiple sites and move from one site to another using this “master view”. A number of mapping tools may be used to create this image, including, for example, the Google and Yahoo brands of mapping tools.

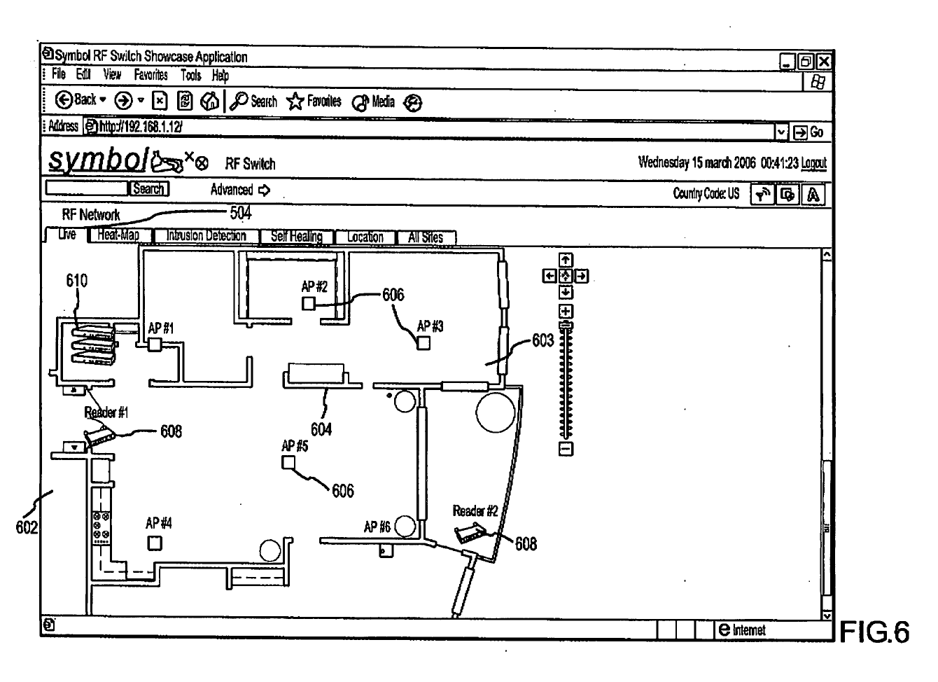

The user is allowed to click on or otherwise select the site indicators shown in FIG. 5 to get a close-up view of that site. In this regard, FIG. 6 depicts an exemplary display in the context of a web browser showing live mapping of network objects at a site. As shown, the display includes a site map 602 with various component indicators and other visual cues superimposed thereon. Site map 602 preferably includes some structural details that allow the position of the various objects in space to be intuited. Such structural details might include, for example, rooms (e.g., room 603), walls (e.g., wall 604), windows, doors, shelving, etc.

Visual indicators are used to note the position of various network elements. In the illustrated embodiments, network switches 610, RF reader 608, and APs 606s are shown. The invention is not so limited, however. The visual indicators might include detailed representations of the actual units, stylized graphics, simple geometrical shapes, or any other suitable graphic.

The position of the various components may be determined in any convenient manner. Suitable techniques include, for example, trilateration (such as used with GPS systems), triangulation, zone aggregation, using information from multiple APs, RFID readers communicated over the network. RFID tags may be located based on business logic applied to the readers.

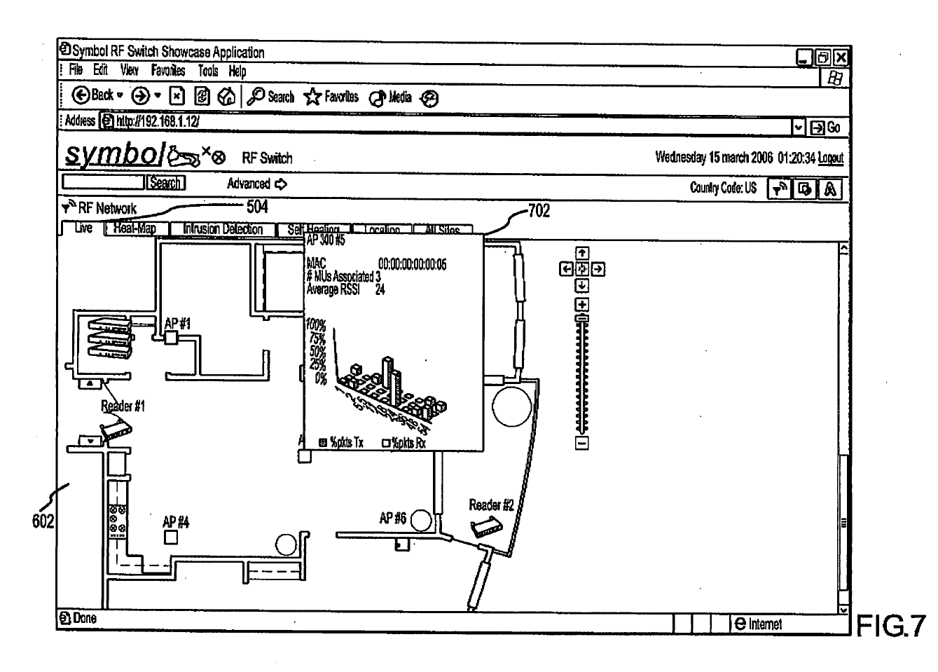

FIG. 7 depicts an exemplary display in the context of a web browser showing information for a particular object at a site, when a user clicks on or otherwise selects an indicator under the “Live” tab. As shown, a pop-up window 702 may be displayed. An assortment of information for a particular component may be included within the window, including, for example, the MAC address, number of associated MUs, Tx and Rx transmission history of an AP, or the like.

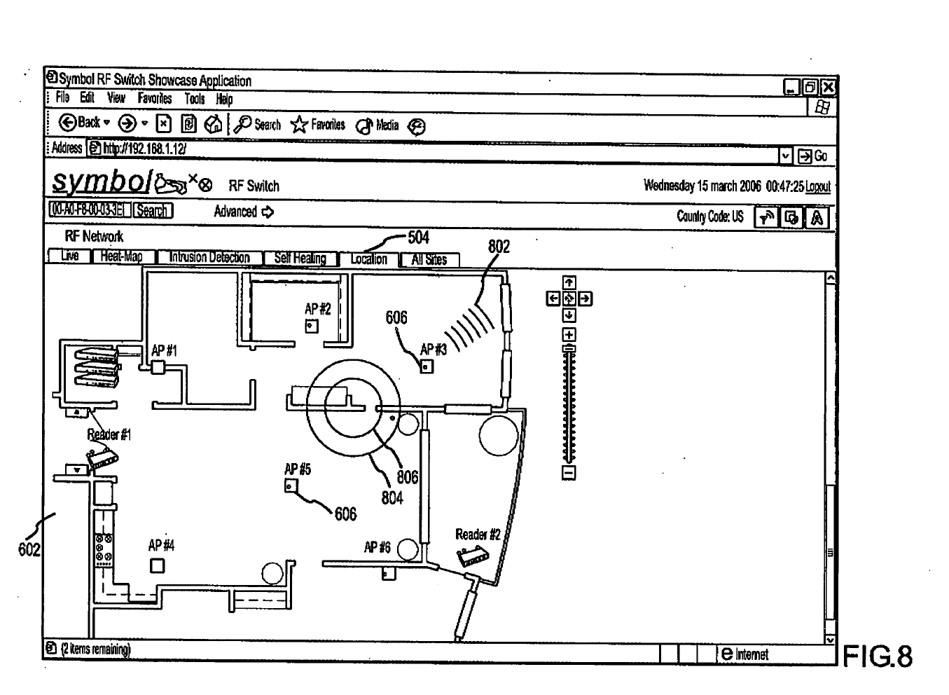

FIG. 8 depicts an exemplary display in the context of a web browser showing the location of particular RF elements (e.g., mobile units, RFID tags, or any other component that communicates via RF) within a site. A series of concentric circles (e.g., circles 802) may be displayed around particular antennas (associated with APs, readers, etc.). In one embodiment, the location of the RF element may not be known precisely, and the certainty of its position may be indicated by circles of different diameters. For example, in one embodiment, the location of an MU is indicated by a circle 806, and in another embodiment (when the MU is perhaps of a different manufacture, or has other wireless characteristics) the location of the MU is indicated by a larger circle 804. RFID tags and other RF elements may be similarly designated. The user may search, select, or otherwise select the RF element whose position is to be displayed. This search may be based on MAC, IP address, RFID tag, or the like.

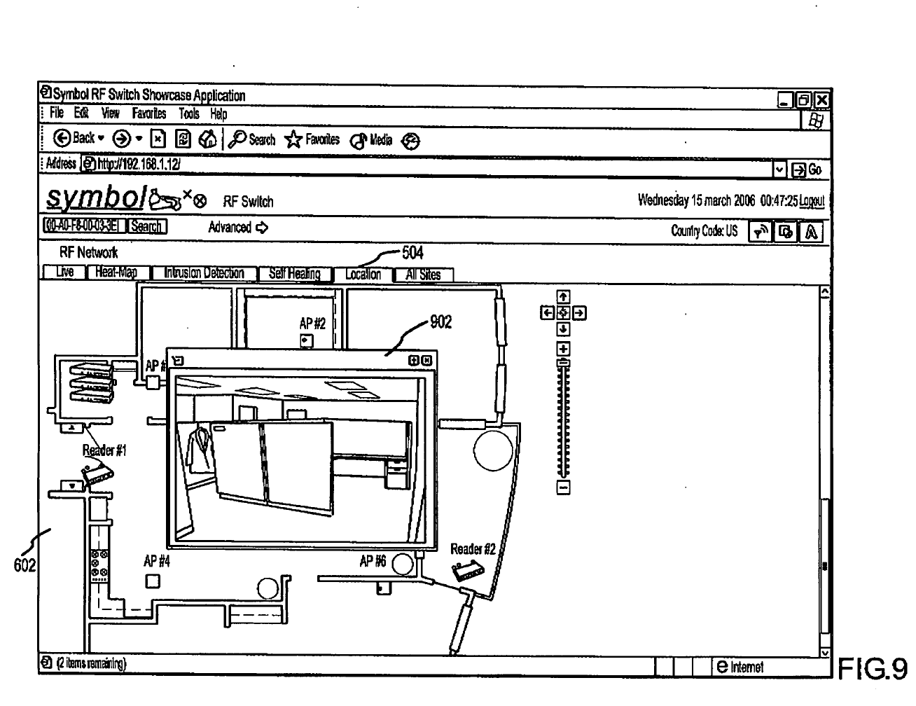

FIG. 9 depicts an exemplary display in the context of a web browser showing a camera image at a particular location within a site. That is, in the event that a camera is located at the site (e.g., attached to an AP, an MU, a reader, or standing alone) and attached to the network, a live streaming video of that cameras field of view may be called up into a separate window 902. Suitable camera controls may also be provided, allowing various object to be located visually in addition to the mapping provided by the web page.

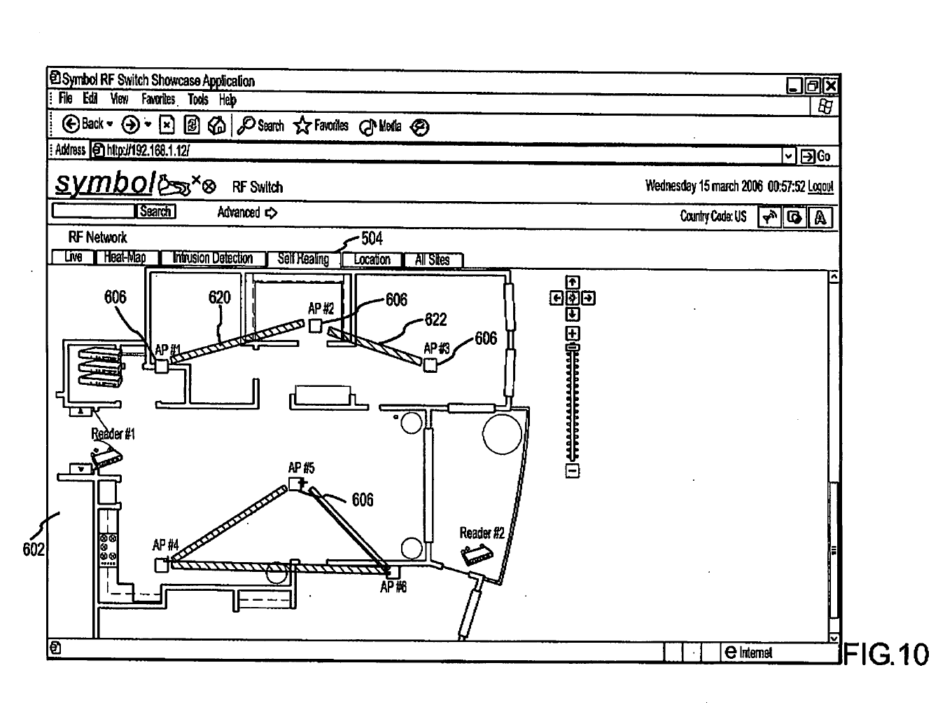

FIG. 10 depicts an exemplary display in the context of a web browser showing the relationship between various access ports within a self-healing group under the “Self Healing” tab. That is, various connectors (displayed using different colors for different neighborhood) may be superimposed on the map so that the administrator can check whether APs and antennae are configured as self-healing neighbors and whether they are acting in a normal mode or “healing” mode.

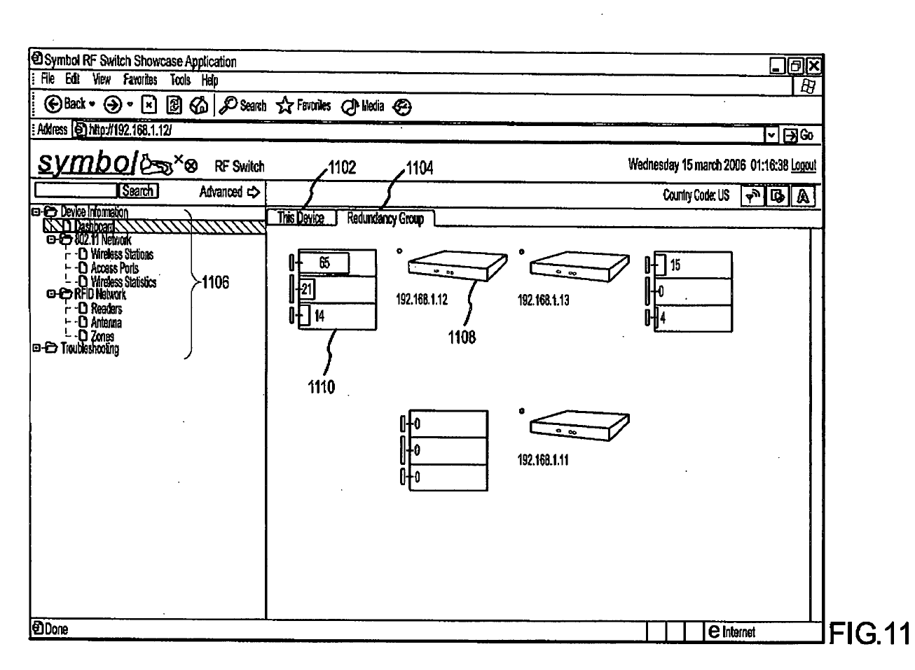

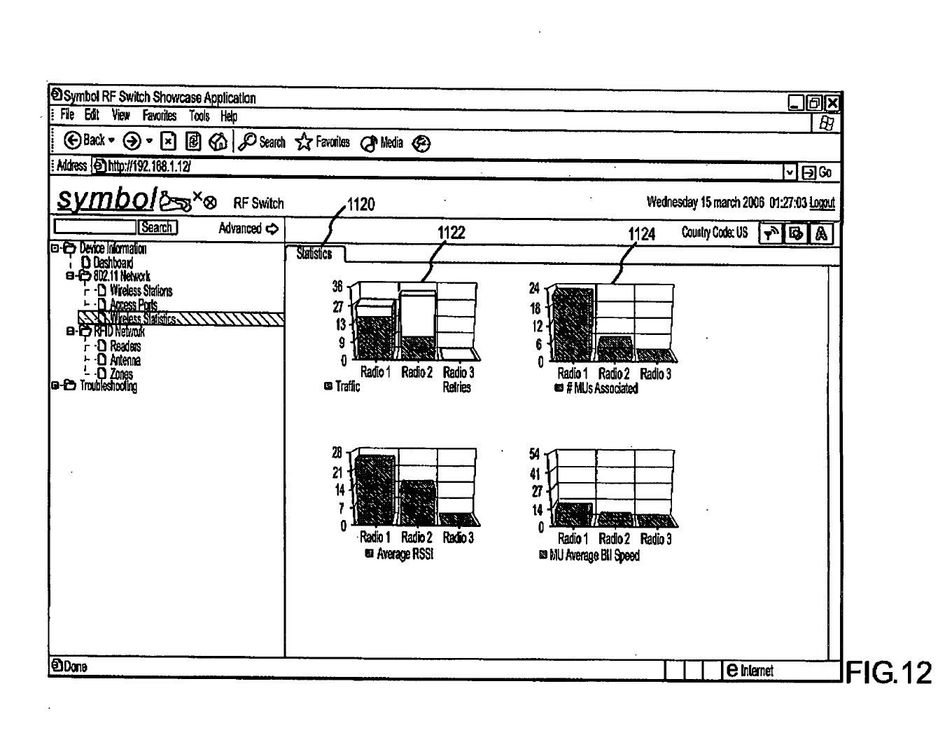

FIG. 11 depicts an exemplary display in the context of a web browser showing device information. Similarly, FIG. 12 depicts an exemplary display in the context of a web browser showing wireless statistics. In FIG. 11, tabs for the current device (1102) and the redundancy group (1104) provide respective sets of graphics describing the state of the system. In this illustration, the switches and corresponding IP address are displayed (1108) along with bar charts showing the number of associated components (1110). A hierarchical menu 1106 may be provided for selecting the type of network and components within the network. Similarly, in FIG. 12, a “Statistics” tab 1120 provides suitable graphics 1122 and 1124 showing statistics detailing traffic, number of retries, etc., for various antennas, MUs, etc.

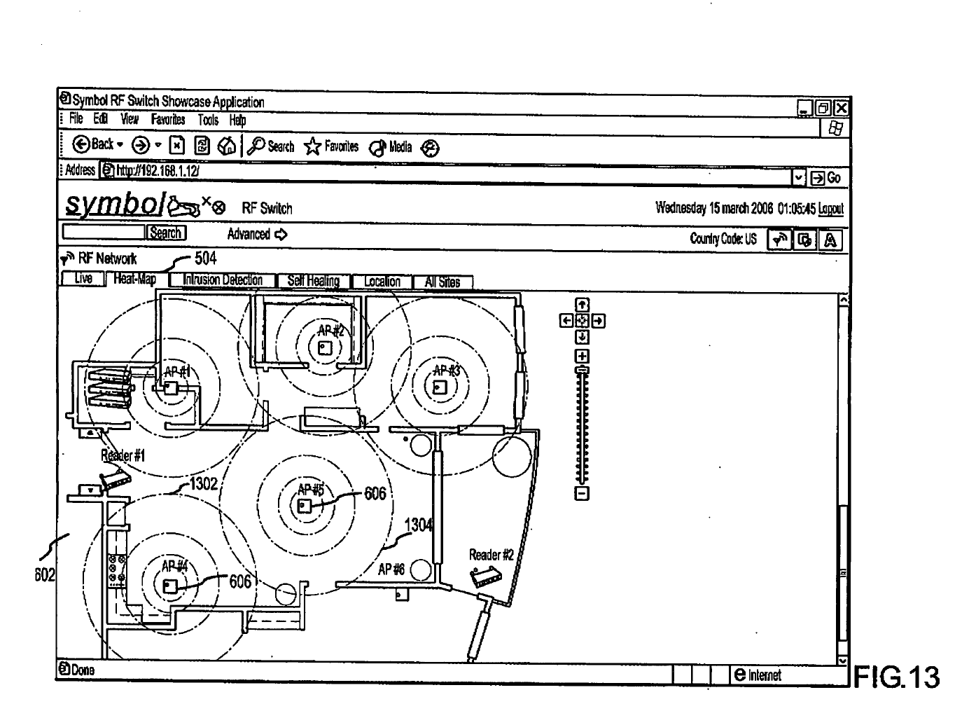

FIG. 13 depicts an exemplary display in the context of a web browser showing “heat maps” for access ports at a site. The heat map shows the range of the antennae, AP, or reader as a gradient (e.g., a gradient of various intensities of the color red), such that areas that are better covered by antennae are brighter (or darker) than other areas. This allows the administrator to determine areas of coverage and configure the system appropriately.

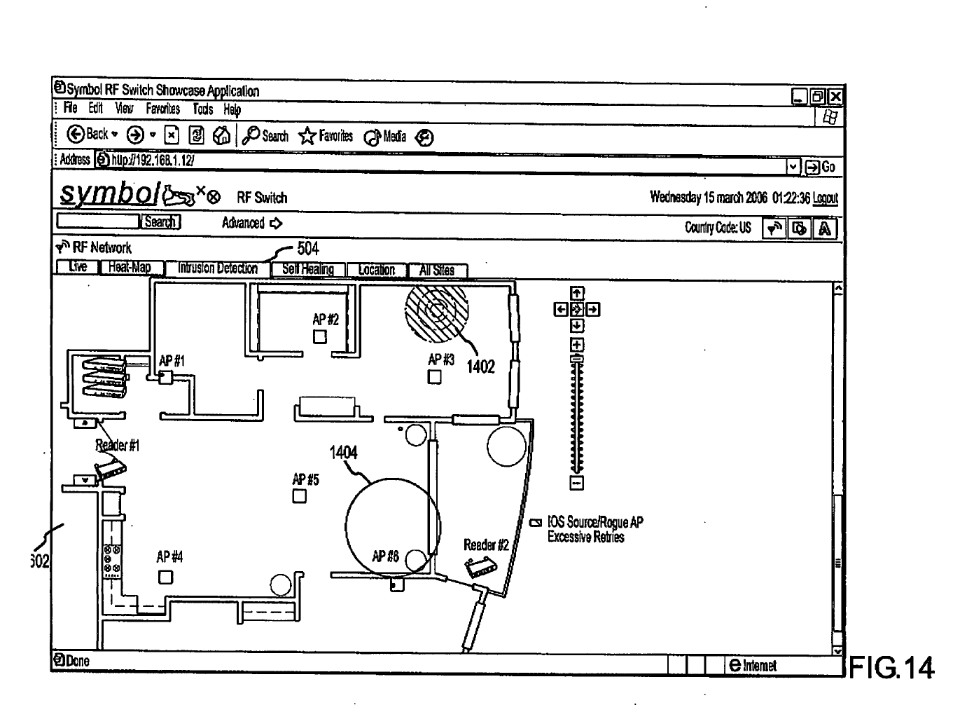

FIG. 14 depicts an exemplary display in the context of a web browser showing intrusion detection at a site under the “Intrusion Detection” tag. That is, the display designates areas 1404 where excessive retries (as determined by some predetermined criterion) have occurred, as well as areas where “rogue” APs or other components have been detected.

It should be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A graphical management system comprising:
a web browser application communicatively coupled to a web service and a graphical management module over a network;
a plurality of wireless devices coupled to the network and having one or more associated antennae, the wireless devices configured to process data received from a plurality of RF elements within range of the antennae;
an RF switch coupled to the network and configured to receive the data and transmit the data to the graphical management module;
the graphical management module configured to provide to the web service graphical information relating to the state of the RF elements.

2. The system of claim 1, wherein the graphical management module is configured to provide graphical information related to the position of the RF elements and the wireless devices.

3. The system of claim 2, wherein the graphical information includes a graphical element superimposed on a two-dimensional map.

4. The system of claim 1, wherein the graphical management module is configured to provide a map of a plurality of sites in which the RF elements exist.

5. The system of claim 1, wherein the graphical management module is configured to provide a graphical indication of traffic within the wireless devices.

6. The system of claim 1, wherein the graphical management module is configured to provide a map of a plurality of sites in which the RF elements exist.

7. The system of claim 1, wherein the graphical management module is configured to provide a heat map of the antennae, wherein the heat map includes graphical elements indicating the respective ranges of the antennae superimposed on a two-dimensional site map.

8. The system of claim 1, wherein the graphical management module is configured to provide intrusion detection comprising graphical elements indicating at least one of rogue wireless devices and excessive retries superimposed upon a two-dimensional site map.

9. The system of claim 1, wherein the graphical management module is configured to provide self-healing antennae information comprising graphical elements indicating network neighborhoods of the antennae.

10. A method for visualizing an RF network, comprising:
providing a web browser application communicatively coupled to a web service and a graphical management module over a network;
providing a plurality of wireless devices coupled to the network and having one or more associated antennae,
receiving, at the wireless devices, data received from a plurality of RF elements within range of the antennae;
receiving, at an RF switch coupled to the network, the data and transmitting the data to the graphical management module;
providing to the web service graphical information relating to the state of the RF elements.

11. The method of claim 1, wherein the graphical management module is configured to provide graphical information related to the position of the RF elements and the wireless devices.

12. The method of claim 11, wherein the graphical information includes a graphical element superimposed on a two-dimensional map.

13. The method of claim 1, wherein the graphical management module is configured to provide a map of a plurality of sites in which the RF elements exist.

14. The method of claim 1, wherein the graphical management module is configured to provide a graphical indication of traffic within the wireless devices.

15. The method of claim 1, wherein the graphical management module is configured to provide a map of a plurality of sites in which the RF elements exist.

16. The method of claim 1, wherein the graphical management module is configured to provide a heat map of the antennae, wherein the heat map includes graphical elements indicating the respective ranges of the antennae superimposed on a two-dimensional site map.

17. The method of claim 1, wherein the graphical management module is configured to provide intrusion detection comprising graphical elements indicating at least one of rogue wireless devices and excessive retries superimposed upon a two-dimensional site map.

18. The method of claim 1, wherein the graphical management module is configured to provide self-healing antennae information comprising graphical elements indicating network neighborhoods of the antennae.
